(19) United States
(12) Patent Application Publication
(10) Pub. No.: US 2023/0367111 A1
(43) Pub. Date: Nov. 16, 2023

(54) MICROSCOPE MODULE BLOCK

(71) Applicant: EASTCOLIGHT (HONG KONG) LIMITED, Kowloon (HK)

(72) Inventor: Chun Hong Johnny Sze, Kowloon (HK)

(73) Assignee: EASTCOLIGHT (HONG KONG) LIMITED, Kowloon (HK)

(21) Appl. No.: 17/741,201

(22) Filed: May 10, 2022

(51) Int. Cl. G02B 21/02; G02B 21/34; G02B 21/26; G02B 21/36

(52) U.S. Cl. CPC G02B 21/025; G02B 21/34; G02B 21/26; G02B 21/364

(57) ABSTRACT

The present invention comprises an illuminator, a slide holder, three detachable objective lenses and a phone mount. It designs with magnetically connected modules set can arrange differently to perform three-distinct functions: a slide-viewing microscope, macro photography camera and slide projector that used with smartphones and tablets. The three detachable objective lenses can be used without a slide holder and illuminator to serve as high powered macro-lenses. Using the low-powered objective lens with the included torch of smartphone enables projection for the sample slide, giving the most dramatic viewing experience across all microscopes. Also, the module block integrate augmented reality (AR) function which offers animated specimen viewing and conducting virtual experiments to enhance the learning experiences. AR is enabled by scanning a dedicated AR slide through the app.

### FIELD OF THE INVENTION

The present invention relates to microscope, especially design with magnetically connected modules set to achieve three-distinct functions, a slide-viewing microscope, macro photography camera and slide projector that used with smartphones and tablets.

### BACKGROUND OF THE INVENTION

In traditional desktop style microscopes usually allow various magnification of the sample to be performed as one single function. Different sets of lens are provided in the microscope for different magnifications. The sets of the lens take up a lot of space and make the microscope even more bulky and complicated to use.

Also the disadvantages of the traditional desktop style microscopes are small imaging, insufficient definition, not suitable for biological observation clear requirement, causes eye strain for long time use and not portable.

Compare to the prior arts, the present invention contained magnetic connected camera blocks for easy attached and interchangeability for mobile devices. It had a 3-in 1 function of microscope, macro photography and projector in one package. It is also compatibility with standard 25×75 mm slide and provision of a LED-backlight. So the present invention makes a further solution to the above disadvantages.

### SUMMARY OF THE INVENTION

The purpose of the present invention is to overcome the shortcomings in the prior art and provide a three-distinct functions, microscope; macro photography and slide projector into one magnetically connected modules block.

The said module block is made up of six magnetically connected modules that can be attached and rearranged. It comprises an illuminator, a slide holder, three detachable objective lenses and a phone mount. When used with a smart device, the modules can arrange differently to perform 3 functions: microscope, macro photography and slide projector.

The three detachable objective lenses can be used without a slide holder and illuminator to serve as high powered macro-lenses. Using the low-powered objective lens with the included torch of smartphone enables projection for the sample slide, giving the most dramatic viewing experience across all microscopes.

Also, the module block integrate augmented reality (AR) function which offers animated specimen viewing and conducting virtual experiments to enhance the learning experiences. AR is enabled by scanning a dedicated AR slide through the app.

### BRIEF DESCRIPTION OF THE DRAWINGS

These and other features, aspects and advantages of the present invention will become better understood with regard to the following description, appended claims, and drawings where:

FIG. 1 is the structure view of the present invention;

FIG. 2a, 2b are the specific embodiment of the present invention used in a microscope function;

FIG. 3 is a specific embodiment of the present invention used in macro photography function;

FIG. 4 is a specific embodiment of the present invention used in slide projector function;

FIG. 5a, 5b, 5c are the specific embodiment of the present invention used in augmented reality function.

### DETAILED DESCRIPTION OF THE INVENTION

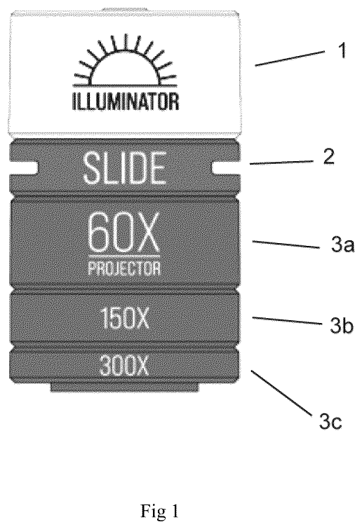

FIG. 1 show the module block comprising with an illuminator 1, a slide holder 2, three detachable objective lenses 3a, 3b, 3c and a phone mount 4.

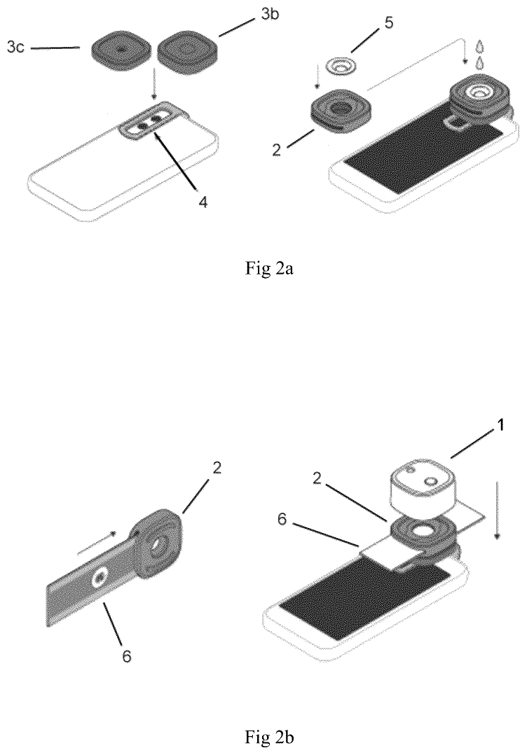

FIGS. 2a and 2b show present invention used in microscope using the provide phone mount 4, illuminator 1, slide holder 2, and medium 3b/high 3c powered objective lens. Insert liquid sample holder 5 or slide sample 6 into the slide holder 2 then turns the smartphone/tablet camera into a microscope that is comparable with traditional microscope in terms of magnification up to 300× and sample slide compatibility.

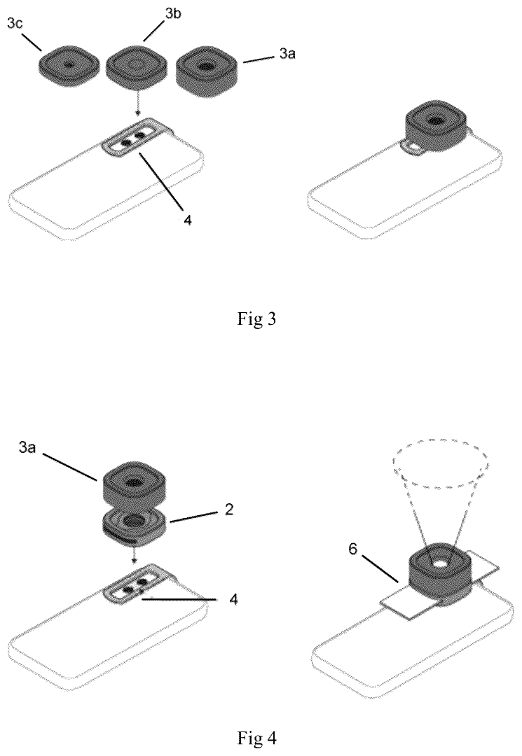

FIG. 3 show present invention used in macro photography using phone mount 4, and high 3c/medium 3b/low 3a powered objective lens. The detachable lenses enable direct viewing of the specimen without altering its original state.

FIG. 4 show present invention used in slide projector using phone mount 4, slide holder 2 and low-powered objective lens 3a. The low-powered objective lens 3a (60×) performs as a projector lens when arranged in this configuration. Using the flashlight of the smartphone as a light source, the image of the slide or the liquid sample 6 (when the image of the slide/liquid holder) is projected using the low-powered lens 3a in dark environment, the image could reach the size of 1.5 meters in diameter.

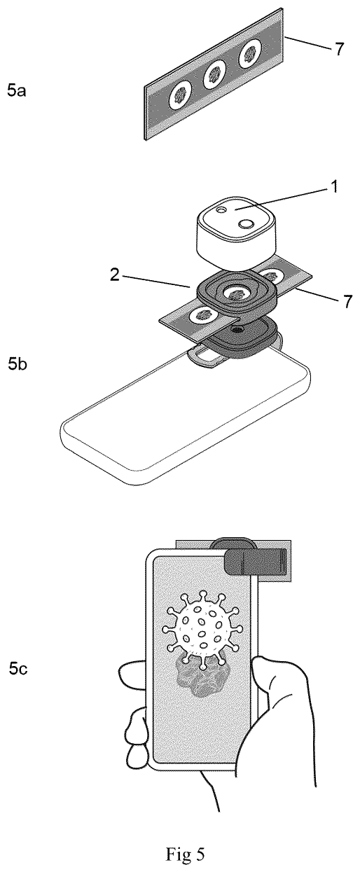

FIGS. 5a, 5b and 5c show present invention 3 steps to activate AR, pick an AR enabled slide 7 insert into the slide holder 2 connect to the illuminator 1 and set up to microscope configuration on the smartphone then scan the AR slide 7 with app. Each individual “maker” (similar to a QR code) that is printed on the slide represents an animated microorganism that will appear in the app when scanned with camera. There are two AR collections to choose from plankton, and bacteria and viruses. Features of the app included animation and database of 11 different organisms for each app, virtual experiments and strategic games.

What is claimed is:

1. A microscope module block comprising with an illuminator, a slide holder, three detachable objective lenses and a phone mount that used with smartphones and tablets, the said modules block is made up of magnetically connected modules that can be attached and rearranged provide a three-distinct functions: microscope; macro photography and slide projector into one magnetically connected module block.

2. A microscope module block of claim 1, said illuminator is used as a LED light source; the said slide holder which holds liquid as well; the said three lenses respectively as high, medium and low magnification power.

3. A microscope module block of claim 1, said using the phone mount, illuminator, slide holder and medium/high powered objective lens turn smartphone/tablet camera into a microscope.

4. A microscope module block of claim 1, said using phone mount, and high/medium/low powered objective lens turn smartphone/tablet camera into macro photography camera.

5. A microscope module block of claim 1, said using phone mount, slide holder, low-powered objective lens and the flashlight of the smartphone as a light source turn smartphone/tablet camera into a slide projector.

6. A microscope module block of claim 1, said the module block integrates augmented reality (AR) function.

7. A microscope module block of claim 6, said to activate AR, pick an AR enabled slide and set up to microscope configuration on the smartphone then scan the AR slide with app.
